(19) United States
(12) Patent Application Publication
(10) Pub. No.: US 2021/0201542 A1
(43) Pub. Date: Jul. 1, 2021

(54) BUILDING MAINTAINING METHOD AND SYSTEM

(71) Applicant: Carrier Corporation, Palm Beach Gardens, FL (US)

(72) Inventors: Yuan Yuan, Shanghai (CN); Jinlei Ding, Shanghai (CN); Guichun Zhou, Shanghai (CN)

(21) Appl. No.: 17/058,350

(22) PCT Filed: Jul. 2, 2019
(86) PCT No.: PCT/US2019/040215

§ 371 Date: Nov. 24, 2020

(30) Foreign Application Priority Data
Jul. 6, 2018 (CN) 201810736422.3

(51) Int. Cl. G06T 11/00; G06K 9/00

(52) U.S. Cl. CPC G06T 11/00; G06T 2210/04; G06K 9/00624

(57) ABSTRACT

A building maintenance system and method. Wherein, the building maintenance method comprises the following steps: S1: obtaining an image within the building; S2: identifying the image, and identifying the location of the image within the building according to the building information model data; S3: obtaining device data and operation parameters at the location; S4: obtaining simulation parameters at the corresponding location in a virtual building; S5: determining display parameters according to the operation parameters and the simulation parameters; S6: generating an superimposed image according to the device data and the display parameters; and S7: superimposing and displaying the superimposed image onto the image. The building maintenance method and system of the present invention has the advantages of simplicity, reliability, and convenient maintenance, etc. By employing the building maintenance system and method of the present invention, the building maintenance efficiency and the user experience of maintenance can be improved.

### TECHNICAL FIELD

The present invention relates to the field of building maintenance and, more particularly, to a building maintenance method for assisting maintenance personnel in performing maintenance operations of a building. The present invention also relates to a building maintenance system.

### BACKGROUND TECHNIQUE

It is known that various pipelines and accessory equipment (for example, central air conditioners, elevators) are increasingly arranged in the modern buildings, for example, central air conditioners, pipelines for central air conditioners and the like. These lines require maintenance personnel to conduct scheduled maintenance. However, the complexity of the pipeline poses many difficulties for maintenance personnel.

Therefore, there is a continuing need for improved building maintenance solution. It is desired that the solution can further improve the user experience of building maintenance and raise maintenance efficiency.

### SUMMARY OF THE INVENTION

One object of the present invention is to provide a building maintenance method that is capable of providing an intelligent visual building maintenance interface. Another object of the present invention is to provide a building maintenance system.

The object of the present invention is achieved by the following technical solution:

A building maintenance method comprising the following steps:

S1: obtaining an image within a building;

S2: identifying the image, and identifying the location of the image within the building according to building information model data;

S3: obtaining device data and operation parameters at the location;

S4: obtaining simulation parameters at the corresponding location in a virtual building;

S5: determining display parameters according to the operating parameters and the simulation parameters;

S6: generating a superimposed image according to the device data and display parameters;

S7: superimposing and displaying the superimposed image onto the image.

Optionally, in step S1, obtaining the image comprises obtaining image information in real time with one or more of the following devices: a mobile phone, a tablet, a wearable device, a smart watch, a camera, or a combination thereof.

Optionally, in step S2, the location of the image within the building is identified according to one or more of the following: a building internal structure, a two-dimensional code (QR code), a barcode, an identification number, an identification mark, or a combination thereof.

Optionally, in step S3, device data is obtained according to the building information model data, the device data includes device information, device location, device model, pipeline orientation, pipeline size, pipeline type, installation time, maintenance record, failure status, or a combination thereof.

Optionally, in step S3, operation parameters are obtained with sensors within pipelines at the location, the operation parameters include fluid temperature, fluid velocity, pressure, flow direction, failure status, or a combination thereof.

Optionally, in step S4, the simulation parameters include simulated operation parameters obtained during simulating the operation of pipeline in the virtual building, the simulation parameters include fluid temperature, fluid velocity, flow direction, or a combination thereof.

Optionally, in step S5, if the operation parameters are consistent with the simulation parameters, then the display parameters include any one of the operation parameters and the simulation parameters; if the operation parameters are inconsistent with the simulation parameters, then the display parameters include both the operation parameters and the simulation parameters.

Optionally, in step S5, if the deviation between the operation parameters and the simulation parameters exceeds a predetermined value, then a failure determination is performed, and the display parameters include the result of the failure determination.

Optionally, in step S5, if no sensor is provided at the location or the sensor at the location fails, then the operation parameters at the location are fitted according to operation parameters obtained with sensors upstream or downstream of the pipeline, and the display parameters include both the operation parameters and the simulation parameters.

Optionally, in step S7, the superimposed image is superimposed onto the image and displayed in real time.

Optionally, steps S1 and S7 are executed on a handheld device, and steps S2 to S6 are executed on a server; wherein the handheld device communicates with the server in a wired or wireless manner.

Optionally, step S1 is executed on a handheld device, and steps S2 to S7 are executed on a server; wherein the handheld device communicates with the server in a wired or wireless manner.

Optionally, the image obtained within the building is a 2D image or a 3D image.

A building maintenance system comprising:

A BIM module configured to store and provide building information model data;

A simulation module configured to simulate the operation of operational pipelines within the building and to provide simulated operation data;

A data collection module configured to obtain an image within the building;

A processing module configured to: receive the image from the data collection module; compare the obtained image with the building information model data in the BIM module to identify an building internal location corresponding to the image; receive operation parameters from the corresponding building internal location; obtain corresponding simulation parameters from the simulation module; and compare the operating parameters with the simulation parameters, so as to determine the display parameters.

Optionally, the method further comprises:

A display module configured to display a superimposed image, wherein the superimposed image comprises at least the image within the building and the display parameters.

Optionally, the processing module is further configured to perform a failure determination while the deviation between the operating parameters and the simulation parameters exceeds a preset value, and the display parameters include the result of the failure determination.

The building maintenance method and system of the present invention has the advantages of simplicity, reliability, and convenience for maintenance, etc. By employing the building maintenance system and method of the present invention, the building maintenance efficiency and the user experience of maintenance can be improved.

### DESCRIPTION OF DRAWINGS

The present invention will be further described in details below with reference to the drawings and the preferred embodiments, but those skilled in the art will understand that these drawings are only drawn for the purpose of explaining the preferred embodiments, and therefore should be construed as limiting the scope of the present invention. In addition, unless specifically stated, the drawings are only intended to illustratively represent the configuration or construction of the described objects and may include exaggerated representations, and the drawings are not necessarily to be depicted in scale.

FIG. 1 is a schematic view of one embodiment of the building maintenance system of the present invention.

### DETAILED DESCRIPTION OF THE PREFERRED EMBODIMENTS

Hereinafter, preferred embodiments of the present invention will be described in details with reference to the accompanying drawings. Those skilled in the art will appreciate that the description is only illustrative, exemplary, and should not be construed as limiting the scope of the invention.

First, it should be noted that the directional terms of top, bottom, upward, downward, etc. as mentioned herein are defined with respect to the directions in each of the drawings. These terms are relative concepts, and thus can vary according to the different locations and the different practical conditions in which they are located. Therefore, these or other directional terms should not be construed as limiting terms.

In addition, it should be noted that any single technical feature described or implied in the embodiments herein, or any single technical feature shown or implied in the drawings, could still continue to combine with other technical feature(s) (or equivalents thereof), so as to obtain other embodiments of the invention that are not directly mentioned herein.

It should be noted that in the different drawings, like reference numerals indicate the same or substantially the same components.

The present invention provides a building maintenance method. According to one embodiment of the invention, the method comprises the following steps:

S1: obtaining a 2D image within the building;

S2: identifying the 2D image, and identifying a location of the 2D image according to building information model data;

S3: obtaining device data and operation parameters at the location;

S4: obtaining simulation parameters at the corresponding location in a virtual building;

S5: determining display parameters according to the operating parameters and the simulation parameters;

S6: generating a superimposed image according to the device data and the display parameters;

S7: Superimposing and displaying the superimposed image onto the 2D image.

In step S1, obtaining the 2D image comprises obtaining 2D image information in real time with one or more of the following devices: a mobile phone, a tablet, a wearable device, a smart watch, a camera, or a combination thereof. In one embodiment of the present invention, user can employ a camera on a tablet, such as iPad, to photograph the interior of the building, and thereby obtain the 2D image. It is readily appreciated that such 2D images can be stationary or dynamic, and can be displayed in real time on a device. It can be understood that a 3D image can also be obtained with the help of a 3D scanning device. In order to facilitate describing this invention, only the embodiment of the 2D image is mentioned below.

In step S2, the location of the 2D image is identified according to one or more of the following: a building internal structure, a two-dimensional code, a barcode, an identification number, an identification mark, or a combination thereof. In one embodiment of the invention, the interior of the building is provided with a number of two-dimensional codes, and these two-dimensional codes are selectively arranged at locations where frequent maintenance is required. While photographing the interior of the building, the user can simultaneously take the two-dimensional codes into the 2D images. By recognizing the two-dimensional codes and comparing the recognition result with the corresponding two-dimensional code information within the building information model data, it is possible to determine the locations within the building where the 2D images are photographed. In addition, it is also possible to identify the location of the 2D image by spatial locating, for example, GPS, wireless Wi-Fi, and the location of the mobile phone base station could be comprehensively applied to determine the location of the user.

Likewise, different locations in a building typically have different appearances, so it is possible to identify the photographed 2D images and compare them with the appearance information at different locations within the building information model data, so as to determine the locations where the 2D images are photographed. It is also possible to further identify the approximate height and angle of the photographing devices from the 2D images, and the information can applied for the further displaying below. The aforementioned identification process can be performed with artificial intelligence system, and the identification process and result can be stored as a portion of big data information, so as to improve the efficiency and accuracy of subsequent identification.

In step S3, device data is obtained according to the building information model data, the device data includes device information, device location, device model, pipeline orientation, pipeline size, pipeline type, installation time, maintenance record, failure status, or a combination thereof. The aforementioned device data may be stored in the building information model data or may be determined according to information in the virtual building.

As used herein, “Building Information Model (BIM)” refers to a building database consisting of a series of three-dimensional models, wherein information in relative to various structural components of the building, various installed equipment, and the pipelines are stored. The building information model may exist in the form of a database on a dedicated memory or in other forms known by those skilled in the art.

As used herein, “virtual building” or Digital Twin refers to a series of characters of the working or operating of equipment within a building, expressing in the form of mathematical formulas. For example, the flow parameters of the working fluid in various pipelines of the central air conditioner can be expressed by fluid mechanics formulas, and the temperature of the working fluid can also be expressed by fluid mechanics and thermodynamic formulas. It will be readily understood by those skilled in the art that the building maintenance method mentioned in the present invention is not limited to the several embodiments disclosed above, but is intended to summarize the mathematical processing of one or more parameters of the equipment that can be expressed by mathematical formulas and associate with the building itself and/or the operation of equipment inside the building. As used herein, “virtual building” may exist either in the form of pure mathematical formulas or mathematical models, and may also be stored or applied in other ways known by those skilled in the art.

By employing a virtual building, a complete model associated with the building itself and/or the operation of the equipment inside the building can be obtained. By means of this model, it is possible to simulate and obtain values of one or more parameters of the equipment throughout the building, and these values represent the operational states that can be generated by the building and the internal equipment under normal operating condition, and can therefore be applied to calibrate and inspect the anomalies that may occur to the buildings and the internal devices.

In step S3, operation parameters are obtained with sensors within the pipelines at the location, the operation parameters include fluid temperature, fluid velocity, flow direction, failure status, or a combination thereof within the pipelines. It is easy to understand that buildings (especially smart buildings) are increasingly using sensors to collect internal information. Operating equipment, such as central air conditioners, are generally provided with various sensors to detect daily operating condition and return information. The information can be collectively collected by a controller or a server. Although some embodiments of the sensor are described above, the present invention is intended to cover various operation parameters that may be generated by the building and the accessory equipment thereof that may be recognized by those skilled in the art.

In step S4, the simulation parameters include simulated operation parameters obtained when the operation of the pipelines is simulated in the virtual building; the simulation parameters include fluid temperature, fluid velocity, pressure, flow direction, or a combination thereof within the pipeline. Various parameters of the working fluid in the pipelines of the accessory device can be simulated and calculated by known thermodynamic and hydrodynamic formulas. For example, central air conditioner typically comprises a cold air outlet and a warm air inlet, thus creating a flow of air in the pipelines. The temperature, velocity and pressure of the air would change during flowing. By means of the mathematical formulas in the virtual building, the parameters at different locations in the pipelines can be accurately calculated.

Furthermore, depending on the design and arrangement of the building and the accessory equipment, parameters such as the flow direction of the working fluid, etc. can be determined. Although the present invention discloses a series of parameters available for simulation calculation by way of embodiments, the existence of other parameters is not excluded. As long as such operation parameters are in relevant to the operation of the building and its accessory equipment, such additional embodiments are intended to be covered by the present invention.

In step S5, the sensed operation parameters and the simulation parameters are compared, in order to determine the display parameters. For example, in one embodiment of the present invention, if the operation parameters are consistent with the simulation parameters, then the display parameters include any one of the operation parameters and the simulation parameters; if the operation parameters are inconsistent with the simulation parameters, then the display parameters include both the operation parameters and the simulation parameters.

By displaying one or more of the operating parameters and the simulation parameters, the user can determine whether the device in this portion is abnormal, facilitating rapid check and inspection of the device, and improving the convenience and reliability of the building maintenance.

Furthermore, if the deviation between the operation parameters and the simulation parameters exceeds a preset value, then a failure test is performed, and the display parameters include the result of determination. For example, the happening of failures can be determined on the basis of sensor status and readings in buildings and accessory equipment, error messages from accessory equipment, or other information.

The aforementioned determining process may be performed with an artificial intelligence server, for example, by employing the processing method of statistics, big data, deep learning, etc. Although one embodiment of obtaining display parameters is disclosed above, the present invention is not limited to the aforementioned embodiments, but is intended to cover other embodiments that may occur to those skilled in the art.

Optionally, in step S5, if no sensor is provided at the location or the sensor at the location fails, then the operation parameters at the location are fitted according to operation parameters obtained with sensors upstream or downstream of the pipelines, and the display parameters include both the operation parameters and the simulation parameters. In one embodiment, if sensor failure occurs, the failed sensor can be displayed in a striking color to alert the user that the reading of this sensor is unreliable, and at the same time the user can be advised to refer to the simulation parameters of the virtual building.

In step S7, the superimposed image is superimposed onto the 2D image and displayed in real time. In one embodiment, the superimposed image may be displayed on a device held by the user to obtain the display effect of Augmented Reality. In another embodiment, the superimposed image may be displayed on a stationary device or provided by a server to one or more clients for further use.

In one embodiment of the invention, the device data may be displayed with rendered 3D models, and the display parameters may be displayed in the manner of numbers, arrows or lines, etc. The device data may, for example, be rendered to generate a 3D model with monochrome or containing transitional colors, and the 3D model is superimposed onto the 2D image obtained in real time. This allows the user to clearly see invisible accessory device, for example behind a ceiling or wall, and to review operation parameters of the device. The aforementioned display effect facilitates the user for conducting maintenance and inspection operation, and improves the user experience.

In one embodiment of the invention, steps S1 and S7 are executed on a handheld device and steps S2 to S6 are executed on a server; wherein the handheld device communicates with the server in a wired or wireless manner. It will be readily understood that embodiments of the present invention do not exclude other communication or display method. For example, user may take a photo, transmit the photo to a server, and the server would identify, render, and superimpose the photo before sending it back to the client. In this embodiment, step S7 is executed on the server.

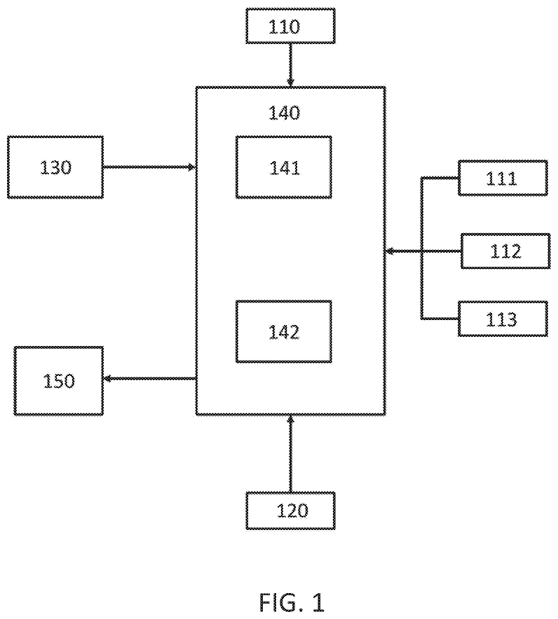

The present invention also provides a building maintenance system configured to perform the aforementioned building maintenance method. FIG. 1 is a structural schematic view of one embodiment of the building maintenance system of the present invention, wherein the building maintenance system 100 comprises the following portions.

A BIM module 110 is configured to store and provide Building Information Model (BIM) data.

A simulation module 120 is configured to simulate the operation of operational pipelines within the building and provide simulated operation data. It is readily understood that the simulation module 120 corresponds to the “virtual building” as described above.

A data collection module 130 is configured to obtain a 2D image within the building.

A processing module 140 is configured to: receive the 2D image from the data collection module 130; compare the obtained 2D image with the building information model data within the BIM module 110, identify a building internal location corresponding to the 2D image; receive operation parameters from the corresponding building internal location; receive the corresponding simulation parameters from the simulation module 120; and compare the operation parameters with the simulation parameters to determine the display parameters.

Furthermore, the processing module 140 is further configured to perform a failure test when the deviation between the operating parameters and the simulation parameters exceeds a preset value, and the display parameters include the result of determination.

Wherein, the processing module 140 may comprise an artificial intelligence module 141 and a rendering module 142. The artificial intelligence module can be constructed by means of deep learning or the like, and comprehensively analyze and process data from the BIM module 110, the simulation module 120, and the data collection module 130, and finally obtain the device data and display parameters as described above. The rendering module 142 generates augmented reality display data for superimposing on the basis of the device data and the display parameters, and transmits the augmented reality display data to the display module.

Furthermore, the BIM module 110 and the simulation module 120 can be provided as separate servers or on the same server along with the processing module 140. The processing module 140 can also be configured to collect data in relevant to Building Management System (BMS) 111, fire and security module 112, and elevator 113, etc., so as to process and analyze these data along with a series of data disclosed above.

The display module 150 is configured to display a superimposed image, wherein the superimposed image comprises at least the image within the building and the display parameters, wherein the display module 150 and the data collection module 130 may be located on the same device or on different devices.

The present invention also relates to a controller comprising a memory, a processor, and a computer program stored on the memory and operable on the processor, wherein the steps of the building maintenance method are implemented when the program is executed by the processor.

The present invention also relates to a computer readable storage medium with a computer program stored thereon, wherein the program can be executed by a processor to implement the steps of the aforementioned building maintenance method.

The present invention is disclosed with reference to the drawings, and also enable those skilled in the art to practice the invention, including making and using any system or system, selecting suitable materials, and using any method of combination. The scope of the present invention is defined by the claimed technical solutions and includes other examples that could occur to those skilled in the art. As long as such other examples include structural elements that are not different from the literal language of the claimed technical solution, or such other examples contain equivalent structural elements that are not substantially different from the literal language of the claimed technical solution, then such other examples should be considered within the scope of protection determined with the technical solution claimed by the present invention.

1. A building maintaining method comprising:
S1: obtaining an image within a building;
S2: identifying the image, and identifying a location of the image within the building according to building information model data;
S3: obtaining device data and operation parameters at the location;
S4: obtaining simulation parameters at corresponding locations in a virtual building;
S5: determining display parameters according to the operation parameters and the simulation parameters;
S6: generating a superimposed image according to the device data and the display parameters; and
S7: superimposing and displaying the superimposed image onto the image.

2. The building maintenance method according to claim 1, wherein, in step S1, obtaining the image comprises obtaining image information in real time with one or more of the following devices: a mobile phone, a tablet, a wearable device, a smart watch, a camera or a combination thereof.

3. The building maintenance method according to claim 1, wherein, in step S2, the location of the image within the building is identified according to one or more of the following: a building internal structure, a two-dimensional code, a barcode, an identification number, an identification mark, or a combination thereof.

4. The building maintenance method according to claim 1, wherein, in step S3, the device data is obtained according to the building information model data, the device data includes device information, device location, device model, pipeline orientation, pipeline size, pipeline type, installation time, maintenance record, failure status, or a combination thereof.

5. The building maintenance method according to claim 1, wherein, in step S3, the operation parameters are obtained with sensors within pipelines at the location, the operation parameters include fluid temperature, fluid velocity, pressure, flow direction, failure status, or a combination thereof within the pipeline.

6. The building maintenance method according to claim 5, wherein, in step S4, the simulation parameters include simulated operation parameters obtained while simulating the operation of pipelines within the virtual building, the simulation parameters include fluid temperature, fluid velocity, and flow direction or a combination thereof within the pipelines.

7. The building maintenance method according to claim 6, wherein, in step S5, if the operation parameters are consistent with the simulation parameters, then the display parameters include any one of the operation parameters and the simulation parameters; and if the operation parameters are inconsistent with the simulation parameters, then the display parameters include both the operation parameters and the simulation parameters.

8. The building maintenance method according to claim 6, wherein, in step S5, if deviation between the operation parameters and the simulation parameters exceeds a predetermined value, then a failure determination is performed, and the display parameters include the result of the failure determination.

9. The building maintenance method according to claim 5, wherein, in step S5, if no sensor is provided at the location or the sensor at the location fails, then the operation parameters are fitted according to the parameters obtained with at least one sensor upstream or downstream of the pipelines, and the display parameters include both the operation parameters and the simulation parameters.

10. The building maintenance method according to claim 1, wherein, in step S7, the superimposed image is superimposed onto the image and displayed in real time.

11. The building maintenance method according to claim 1, wherein, steps S1 and S7 are executed on a handheld device, and steps S2 to S6 are executed on a server; wherein the handheld device communicates with the server in a wired or wireless manner.

12. The building maintenance method according to claim 1, wherein, step S1 is executed on a handheld device, and steps S2 to S7 are executed on a server; wherein the handheld device communicates with the server in a wired or wireless manner.

13. The building maintenance method according to claim 1, wherein the image obtained within the building is a 2D image or a 3D image.

14. A building maintenance system comprising:
a BIM module configured to store and provide building information model data;
a simulation module configured to simulate operation of operational pipelines within the building and to provide simulated operation data;
a data collection module configured to obtain an image within the building; and
a processing module configured to:
receive the image from the data collection module;
compare the received image with the building information model data in the BIM module, so as to identify a building internal location corresponding to the image;
receive operation parameters from a corresponding building internal location;
obtain corresponding simulation parameters from the simulation module; and
compare the operation parameters with the simulation parameters, so as to determine display parameters.

15. The building maintenance system of claim 14, further comprising:
a display module configured to display a superimposed image, wherein the superimposed image comprises at least the image within the building and the display parameters.

16. The building maintenance system according to claim 14, wherein the processing module is further configured to perform failure determination while a deviation between the operating parameters and the simulation parameters exceeds a preset value, and the display parameters include the result of the failure determination.
